(19) United States
(12) Patent Application Publication
(10) Pub. No.: US 2012/0003433 A1
(43) Pub. Date: Jan. 5, 2012

(54) DECORATION FILM, DECORATION DEVICE, AND METHOD FOR MANUFACTURING DECORATION DEVICE

(75) Inventor: Shih-Min Huang, Taipei City (TW)

(73) Assignee: SiPix Chemical Inc., Taoyuan County (TW)

(21) Appl. No.: 12/828,306

(22) Filed: Jul. 1, 2010

(51) Int. Cl. B32B 37/12; B44C 1/00

(52) U.S. Cl. 428/195.1; 156/298

(57) ABSTRACT

A decoration film, a decoration device and a method for manufacturing a decoration device are provided. The decoration film includes a substrate, a releasing layer, a pattern layer and an adhesion layer. The releasing layer is disposed on the substrate. The pattern layer is disposed on the releasing layer at a side far from the substrate. The adhesion layer is disposed on a portion of the pattern layer.

### BACKGROUND OF THE INVENTION

1. Field of the Invention

The present invention generally relates to a decoration film, a decoration device and a method for manufacturing a decoration device, in particular, to a decoration film having three-dimensional pattern, a decoration device and a method for manufacturing a decoration device.

2. Description of Related Art

Conventionally, the illustrations or decorations formed on the surface of the plastic housing are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the housing, the improper accumulation of the coating material is worse.

To solve the abovementioned problem, specific decoration processes using a decoration film which has predetermined decoration layers formed on a substrate are provided. The decoration processes include an in-mold decoration (IMD) technique, a heat transfer printing process, a sublimation heat transfer process, a hot stamping process, an ink jet printing process, a water transfer printing process, and the like. The process of the IMD technique includes placing the decoration film into a mold of the injection machine, injecting a melted resin at a side of the decoration film in the mold so that the melted resin and the decoration layers of the decoration film are combined to form a decoration device, and thereafter ejecting the decoration device from the mold. Accordingly, the in-mold decoration process is completed.

However, a surface of a decorated housing is therefore turned into almost a plane after fabricating by the conventional IMD process, such that the surface of the decorating product has no three-dimension sense.

### SUMMARY OF THE INVENTION

The invention directs to a decoration film having a three-dimensional pattern.

The invention directed to a decoration device having a tactile perception of three-dimensional pattern.

The invention directed to a method for manufacturing a decoration device, so as to fabricate a decoration device aforementioned.

The invention provides a decoration film including a substrate, a releasing layer, a pattern layer and an adhesion layer. The releasing layer is disposed on the substrate. The pattern layer is disposed on the releasing layer at a side far from the substrate. The adhesion layer is disposed on a portion of the pattern layer.

In an embodiment of the invention, the decoration film further includes a durable layer disposed on the releasing layer and located between the releasing layer and the pattern layer.

In an embodiment of the invention, the durable layer has a thickness of at least 5 μm.

In an embodiment of the invention, the adhesion layer has a thickness of at least 5 μm.

In an embodiment of the invention, the pattern layer has a thickness of at least 1 μm.

The invention also provides a decoration device including a body and a decoration film. The body has an outer surface. The decoration film is disposed on a portion of the outer surface of the body, wherein the decoration film includes a pattern layer and an adhesion layer. The pattern layer is disposed above the portion of the outer surface. The adhesion layer is disposed between the outer surface of the body and the pattern layer, wherein the adhesion layer is conformally to the pattern layer.

In an embodiment of the invention, the decoration film further includes a durable layer disposed on the pattern layer and being exposed, wherein the durable layer is conformed to the pattern layer.

In an embodiment of the invention, the durable layer has a thickness of at least 5 μm.

In an embodiment of the invention, the adhesion layer has a thickness of at least 5 μm.

In an embodiment of the invention, the pattern layer has a thickness of at least 1 μm.

The invention further provides a method for manufacturing a decoration device, and the method includes following steps. A substrate having a releasing layer formed thereon is provided. A pattern layer is formed on the releasing layer at a side far from the substrate. An adhesion layer is formed on a portion of the pattern layer, wherein a decoration film is defined by the substrate, the releasing layer, the pattern layer and the adhesion layer. A body is formed on the adhesion layer so as to closely attach the body to the adhesion layer.

In an embodiment of the invention, a method of forming the body includes following steps. A plastic material is disposed on the adhesion layer at a side far from the pattern layer. The plastic material is cured to form the body, so that the decoration film is closely attached to the body by the adhesion layer.

In an embodiment of the invention, the plastic material is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof.

In an embodiment of the invention, a method for attaching the body to the adhesion layer closely includes the following steps. The decoration film is disposed on the body. A heat transfer printing process is performed to the decoration film. The decoration film and the body are disposed in a chamber. Air is extracted from the chamber, so that the decoration film is closely attached to the body by the adhesion layer.

In an embodiment of the invention, the heat transfer printing process comprises a heating process and a pressing process.

In an embodiment of the invention, before the pattern layer is formed, the method further includes forming a durable layer on the releasing layer.

In an embodiment of the invention, the durable layer has a thickness of at least 5 μm.

In an embodiment of the invention, after the body is formed, the method further includes removing the substrate and the releasing layer thereon from the body by applying a release force.

In an embodiment of the invention, the adhesion layer has a thickness of at least 5 μm.

In an embodiment of the invention, the pattern layer has a thickness of at least 1 μm.

In view of the above, a three-dimensional pattern of the decoration film can be fabricated by designing the patterned adhesion layer and the underlying pattern layer. After the transfer, the decoration film with the three-dimensional pattern is thus formed on the outer surface of the body. Accordingly, the decoration device of the present invention can be provided with an obvious tactile perception of the three-dimensional pattern.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or another material layer, and may also mean that some interlayer is interrupted between the material layer and the substrate or between the material layer and another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a decoration film according to one embodiment of the present invention.

FIG. 1B is a schematic cross-sectional view of a decoration film according to another embodiment of the present invention.

FIG. 1C is a schematic cross-sectional view of a decoration film according to still another embodiment of the present invention.

FIG. 1D is a schematic cross-sectional view of a decoration film according to still another embodiment of the present invention.

FIG. 2 is a schematic cross-sectional view of a decoration device according to one embodiment of the present invention.

FIG. 3 is a flow chart of a method for manufacturing a decoration device according to one embodiment of the present invention.

### DESCRIPTION OF THE. EMBODIMENTS

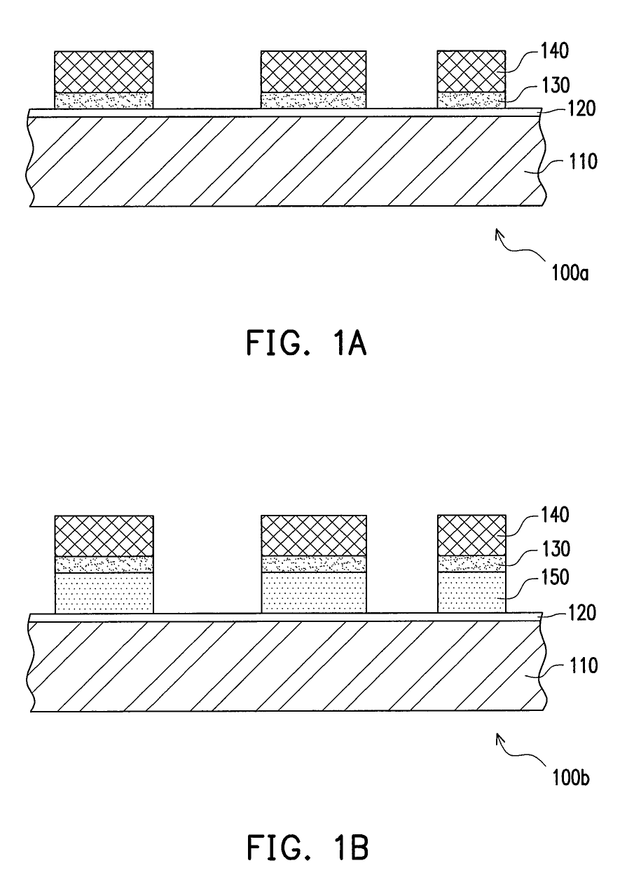

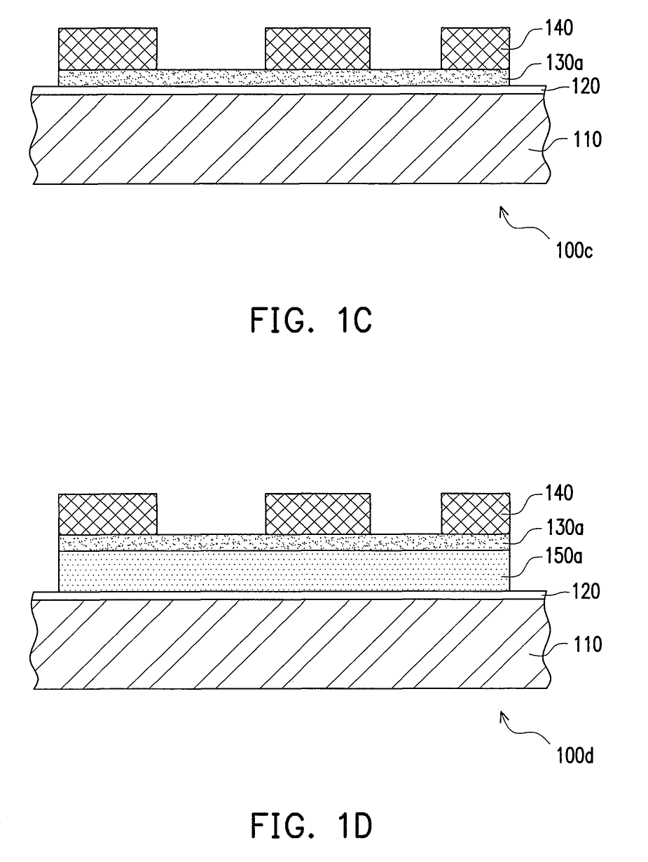

FIG. 1A is a schematic cross-sectional view of a decoration film according to one embodiment of the present invention. Referring to FIG. 1A, a decoration film 100a including a substrate 110, a releasing layer 120, a pattern layer 130 and an adhesion layer 140 is provided. The releasing layer 120, the pattern layer 130 and the adhesion layer 140 are sequentially formed on the substrate 110. Specifically, the releasing layer 120 completely covers the substrate 110, the pattern layer 130 is disposed on a portion of the releasing layer 120 at a side far from the substrate 130, namely, the pattern layer 130 exposes a portion of the releasing layer 120, and the adhesion layer 140 is conformally disposed on the pattern layer 130. Herein, the term “conformally disposed”, in the context of the present invention, is intended to indicate that two layers (such as the adhesion layer 140 and the pattern layer 130) having the same shape are stacked mutually. In addition, the pattern layer 130 and the adhesion layer 140 disposed thereon in the present embodiment can be regarded as a three-dimensional pattern.

In addition, a material of the substrate 110 can be polyethylene terephthalate (PET), polyethylene naphthalate (PEN), polyethylene glycol-co-cyclohexane-1,4 dimethanol terephthalate (PETG), thermoplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer, cyclo olefin copolymer (COC) and a combination thereof, but the invention is not restricted herein. It is noted that the substrate 110 is flexible for facilitating the subsequent process.

The releasing layer 120 is configured for temporally adhering the substrate 110 and the pattern layer 130 in order to facilitate lifting off the substrate 110 after the transfer process. Accordingly, the releasing layer 120 is usually a thin film with low surface tension which can be made of a wax, a paraffin, or silicone, or an impermeable thin film with high smoothness which can be made of an irradiation curable multi-functional acrylic, silicone acrylate, epoxy, vinyl, allyl vinyl compound, unsaturated polyester or a mixture thereof. A material of the releasing layer 120 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

The pattern layer 130 can be made of any ink or printable material by the printing. In addition, the pattern layer 130 of the present embodiment has a thickness of at least 1 μm, for example. Furthermore, the adhesion layer 140 of the present embodiment has a thickness of at least 5 μm. The adhesion layer 140 can be made of polyacrylate, polymethacrylate, polystyrene, polycarbonate, polyurethane, polyester, polyamide, epoxy resin, ethylene vinyl acetate (EVA), thermoplastic elastomer, the like, a copolymer thereof, a blend thereof, or a mixture thereof.

In the decoration film 100a of the present embodiment, the pattern layer 130 is exclusively disposed on the portion of the releasing layer 120, and the adhesion layer 140 is conformally disposed on the pattern layer 130. Therefore, compared with the prior art, the decoration film 100a of the present embodiment has a three-dimensional pattern.

It should be noted that in the present embodiment, the pattern layer 130 is disposed on the portion of the releasing layer 120, namely, the pattern layer 130 is partially disposed on the releasing layer 120, but the present embodiment is not limited herein. In other embodiment, the pattern layer 130a of the decoration film 100dc can also be completely disposed on the releasing layer 120 so as to avoid an issue of alignment error between the pattern layer 130a and the adhesion layer 140 due to insufficient alignment accuracy, as shown in FIG. 1C.

FIG. 1B is a schematic cross-sectional view of a decoration film according to another embodiment of the present invention. Referring to FIGS. 1A and 1B, the decoration film 100b in FIG. 1B is similar to the decoration film 100a in FIG. 1A except that the decoration film 100b in FIG. 1B further includes a durable layer 150. In more details, the durable layer 150 is disposed on the releasing layer 120. Herein, the durable layer 150 is located between the releasing layer 120 and the pattern layer 130, and the durable layer 150 is conformed to the pattern layer 130. Namely, the durable layer 150 expose a portion of the releasing layer 120. Specifically, a three-dimensional pattern of the decoration film 100b of the present embodiment can be defined by the durable layer 150, the pattern layer 130 and the adhesion layer 140. In addition, the durable layer 150 of the present embodiment has a thickness of at least 5 μm.

In the present embodiment, the durable layer 150 serves as a protective layer to the pattern layer 130. Suitable raw materials for the durable layer 150 may include, but are not limited to, radiation curable multifunctional acrylates including epoxy acrylates, polyurethane acrylates, polyester acrylates, silicone acrylates, glycidyl acrylates, epoxides, vinyl esters, diallyl phthalate, vinyl ethers and blends thereof. The durable layer 150 may comprise a condensation polymer or copolymer, such as epoxy, polyurethane, polyamide, polyimide, melamine formaldehyde, urea formaldehyde or phenol formaldehyde. The durable layer 150 may comprise a sol-gel silicate or titanium ester.

The durable layer 150 may be partially or fully cured. If partially cured, a post curing step will be employed after the molding and/or transferring step to enhance the durability, particularly hardness, scratch and oil resistance. In addition, to improve the release properties, the raw material, particularly the low molecular weight components of the durable layer 150 is preferably not permeable into the releasing layer 120. After the durable layer 150 is coated and cured or partially cured, it should be marginally compatible or incompatible with the releasing layer 120. Binders and additives such as thickeners, surfactants, dispersants, UV stabilizers or antioxidants may be used to control the rheology, wettability, coating properties, weatherability and aging properties. Fillers such as silica, Al.sub.2O.sub.3, TiO.sub.2, CaCO.sub.3, microcrystalline wax or polyethylene, Teflon or other lubricating particles may also be added to improve, for example, scratch resistance and hardness of the durable layer 150. The durable layer 150 is usually about 2 to about 20 microns, preferably about 3 to about 12 microns in thickness. The durable layer 150, if present, is preferably transparent in a window area.

In addition to the materials described above, other suitable compositions for the optional durable layer 150 are disclosed in US 2005-0181204, US 2005-0171292, and US 2006-0093813, the contents of all of which are incorporated herein by reference in their entirely. For example, US 2005-0181204 discloses a durable layer 150 composition which comprises a thermally crosslinkable and photochemically or radically graftable polymer, a thermal crosslinker and a radiation curable multifunctional monomer or oligomer; US 2005-0171292 discloses a durable layer 150 composition which comprises a polymer or copolymer having at least one carboxylic acid or acid anhydride functionality for thermal crosslinking and at least one UV crosslinkable functionality; and US 2006-0093813 discloses a durable layer 150 composition which comprises an amino crosslinker, a UV curable monomer or oligomer having at least one functional group reactive with the amino crosslinker, an acid catalyst; and a photoinitiator.

It should be noted that in the present embodiment, the durable layer 150 is disposed on the portion of the releasing layer 120, and the pattern layer 130 is conformally disposed on the durable layer 150, namely, the pattern layer 130 and the underlying durable layer 150 are partially disposed on the releasing layer 120, but the present embodiment is not limited herein. In other embodiment, the durable layer 150a and the pattern layer 130a of the decoration film 100d can also be completely disposed on the releasing layer 120 in order to avoid an issue of alignment error between the pattern layer 130a, the durable layer 150a and the adhesion layer 140 due to insufficient alignment accuracy, as shown in FIG. 1D.

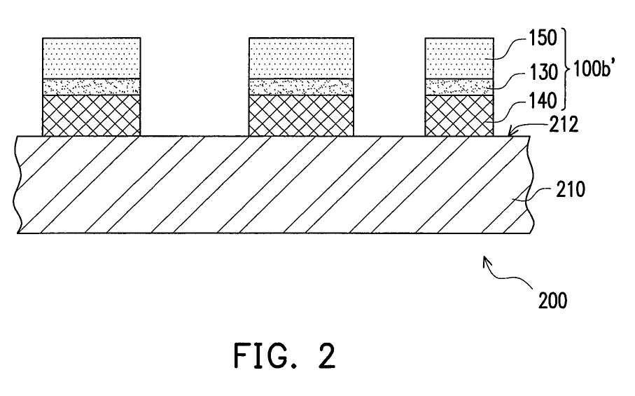

FIG. 2 is a schematic cross-sectional view of a decoration device according to one embodiment of the present invention. Referring to FIG. 2, a decoration device 200 including a body 210 and a decoration film 100b′ is provided. Herein, the decoration film 100b′ of the present embodiment can be transferred into the body 210 by a transfer process to form the decoration device 200. The transfer process includes an in-mold labelling (IML), an in-mold film (IMF), an in-mold roller (IMR), a heat transfer printing, a sublimation heat transfer, a hot stamping, an ink-jet printing and water transfer printing.

In more detail, the body 210 has an outer surface 212. A material of the body 210 can be polycarbonate (PC), acrylonitrile butadiene styrene (ABS), polymethylmethacrylate (PMMA), polyoxymethylene (POM), polybutylene terephthalate (PBT), polypropylene (PP), polymethylmethacrylate (PMMA), MMA-St (MS), acrylonitrile butadiene styrene (ABS), polystyrene (PS), polyethylene terephthalate (PET), polyoxymethylene (POM) and a combination thereof, but the invention is not restricted herein.

The decoration film 100b′ is disposed on a portion of the outer surface 212 of the body 210, and the decoration film 100b′ of the present embodiment includes a pattern layer 130, an adhesion layer 140 and a durable layer 150. The pattern layer 130 is disposed above the portion of the outer surface 212 of the body 210. The adhesion layer 140 is disposed between the outer surface 212 of the body 210 and the pattern layer 130, so that the decoration film 100b′ is closely attached to the body 210 by the adhesion layer 140. The durable layer 150 is exposed and disposed on the pattern layer 130. Specifically, the adhesion layer 140 is conformally to the pattern layer 130, and the durable layer 150 is conformed to the pattern layer 130. The durable layer 150, the pattern layer 130 and the adhesion layer 140 in the present embodiment can be regarded as a three-dimensional pattern.

The material and the formulation information of the pattern layer 130, the adhesion layer 140 and the durable layer 150 have been described above therefore will not be described herein. Thus, a relevant illustration can be referred to the foregoing embodiments. In should be noted that, in the present embodiment, the durable layer 150 is configured for protecting the pattern layer 130, so that the disposition of the durable layer 150 in other embodiments may be omitted.

In brief, since the decoration device 200 of the present embodiment has the decoration film 100b′ which is exclusively disposed on the portion of the outer surface 212 of the body 210, compared to the conventional decoration housing having a plane surface, the decoration device 200 of the present embodiment may have the better three-dimension sense.

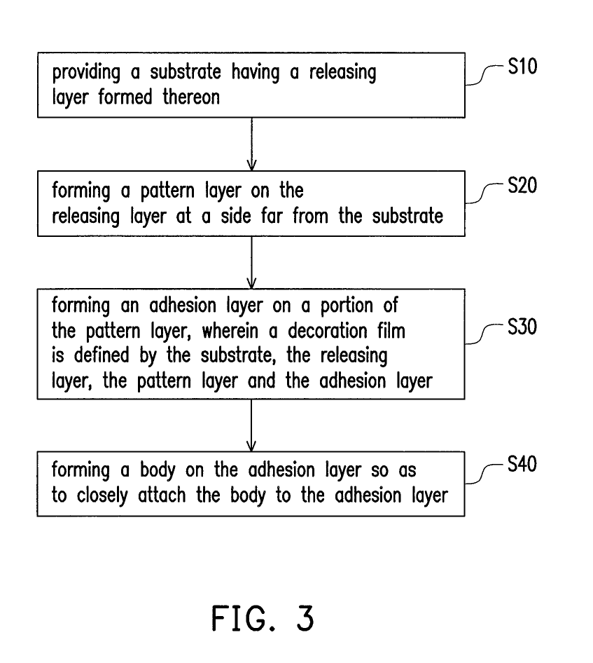

In the aforementioned descriptions, only the decoration film 100a, 100b and the decoration device 200 are introduced, and a manufacturing method thereof is not mentioned. Therefore, one embodiment is provide below for describing the manufacturing method of the decoration device 200 is described in detail with reference of FIG. 3.

FIG. 3 is a flow chart of a method for manufacturing a decoration device according to one embodiment of the present invention. Referring to FIG. 1A (or 1B-1D), 3, according to the manufacturing method of the decoration device 200 of the present embodiment, first, the substrate 110 having the releasing layer 120 formed thereon is provided, step S10. The materials of the substrate 110 and the releasing layer 120 have been described above therefore will not be described herein.

Next, referring to FIGS. 1B, 1D, and 3, optionally, the durable layer 150 (or the durable layer 150a) is formed on the releasing layer 120 at a side far from the substrate 110, wherein the durable layer 150 can expose a portion of the releasing layer 120 or the durable layer 150a can completely cover the releasing layer 120. The material and the thickness of the durable layer 150 (or the durable layer 150a) have been described above therefore will not be described herein.

Next, referring to FIG. 1A (or 1B-1D), 3, the pattern layer 130 (or the pattern layer 130a) is formed on the releasing layer 120 at a side far from the substrate 110, step 20. Herein, when a durable layer 150 is present, the pattern layer 130 can be conformed to the durable layer 150 or the pattern layer 130a can completely cover the durable layer 150a. In addition, the material and the thickness of the pattern layer 130 (or the pattern layer 130a) have been described above therefore will not be described herein. Furthermore, a method of forming the pattern layer 130 (or the pattern layer 130a) may be carried out by any printing techniques, such as flexographic, driographic, electro photographic or lithographic printing. Other printing techniques, such as stamping, screen printing, gravure printing, ink jet printing or thermal printing may also be suitable.

Next, referring to FIG. 1A (or 1B-1D) and 3, the adhesion layer 140 is formed on a portion of the pattern layer 130, wherein a decoration film 100a (or 100b) is defined by the substrate 110, the releasing layer 120, the pattern layer 130 (or the pattern layer 130a), the adhesion layer 140 (and the durable layer 150 or the durable layer 150a), step 30. Now, manufacturing of the decoration film 100a (or 100b, 100c, 100d) with the three-dimensional pattern is completed.

Finally, referring to FIGS. 2 and 3, the body 210 is formed on the adhesion layer 140 so as to closely attach the body 210 to the adhesion layer 140, step S40. In more detail, in the present embodiment, the decoration film 100a (or 100b, 100c, 100d) adheres to the outer surface 212 of the body 210 through the adhesion layer 140. A method of forming the body 210 includes following steps. First, a plastic material is disposed on the adhesion layer 140 at a side far from the pattern layer 130, and then, the plastic material is cured to form the body 210 so that the decoration film 100a (or 100b, 100c, 100d) is closely attached to the body 210 by the adhesion layer 140. Herein, the plastic material is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof, but is not limited to. After the body 210 is formed, the substrate 110 and the releasing layer 120 can be released from the body 210 by applying a release force to expose the durable layer 150 (or the pattern layer 130), as show in FIGS. 2, 3.

It should be noted that in the present embodiment, the adhesion layer 140 is partially disposed on the pattern layer 130a or the durable layer 150a, so that the portions of the releasing layer 120, the pattern layer 130a and the durable layer 150a which are not located below the adhesion layer 140 will be released from the body 210 at the same time with the substrate 110 by applying the release force. Thereby, a three-dimensional pattern composed of the adhesion layer 140, the pattern layer 130 (and the durable layer 150) is formed on the outer surface 212 of the body through the transfer process. Now, manufacturing of the decoration device 200 with three-dimension sense is completed.

In other embodiments, a method for attaching the body 210 to the adhesion layer 140 closely may be used the following steps. First, the decoration film 100a (or 100b, 100c, 100d) is disposed on the body 210. Next, a heat transfer printing process is performed to the decoration film 100a (or 100b, 100c, 100d). Herein, the heat transfer printing process includes a heating process and a pressing process. The substrate 110 of the decoration film 100a (or 100b, 100c, 100d) is pressurized and heated, such that the adhesion layer 140 adheres on the body 210. Next, the decoration film 100a (100b, 100c, 100d) and the body 210 are disposed in a chamber. Then, air is extracted from the chamber, so that the decoration film 100a (or 100b, 100c, 100d) is closely attached to the body 210 by the adhesion layer 140. Finally, the substrate 110 and the releasing layer 120 formed thereon can be released from the body 210 by applying a release force to expose the durable layer 150 (or the pattern layer 130). Now, manufacturing of the decoration device 200 with three-dimension sense is completed.

In summary, the three-dimensional pattern of the decoration film can be fabricated by designing the patterned adhesion layer and the underlying pattern layer. After the transfer process, the decoration film with the three-dimensional pattern is thus formed on the outer surface of the body. Accordingly, the decoration device of the present invention can be provided with an obvious tactile perception of the three-dimensional pattern.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film, comprising:
a substrate;
a releasing layer disposed on the substrate;
a pattern layer disposed on the releasing layer at a side far from the substrate; and
an adhesion layer disposed on a portion of the pattern layer.

2. The decoration film as claimed in claim 1, further comprising a durable layer disposed on the releasing layer and located between the releasing layer and the pattern layer.

3. The decoration film as claimed in claim 2, wherein the durable layer has a thickness of at least 5 μm.

4. The decoration film as claimed in claim 1, wherein the adhesion layer has a thickness of at least 5 μm.

5. The decoration film as claimed in claim 1, wherein the pattern layer has a thickness of at least 1 μm.

6. A decoration device, comprising:
a body having an outer surface; and
a decoration film disposed on a portion of the outer surface of the body, wherein the decoration film comprises:
a pattern layer disposed above the portion of the outer surface; and
an adhesion layer disposed between the outer surface of the body and the pattern layer, wherein the adhesion layer is conformally to the pattern layer.

7. The decoration device as claimed in claim 6, wherein the decoration film further comprises:
a durable layer disposed on the pattern layer and being exposed, wherein the durable layer is conformed to the pattern layer.

8. The decoration device as claimed in claim 7, wherein the durable layer has a thickness of at least 5 μm.

9. The decoration device as claimed in claim 6, wherein the adhesion layer has a thickness of at least 5 μm.

10. The decoration device as claimed in claim 6, wherein the pattern layer has a thickness of at least 1 μm.

11. A method for manufacturing a decoration device, comprising:
providing a substrate having a releasing layer formed thereon;
forming a pattern layer on the releasing layer at a side far from the substrate;
forming an adhesion layer on a portion of the pattern layer, wherein a decoration film is defined by the substrate, the releasing layer, the pattern layer and the adhesion layer; and
forming a body on the adhesion layer so as to closely attach the body to the adhesion layer.

12. The method for manufacturing the decoration device as claimed in claim 11, wherein a method of forming the body comprises:
disposing a plastic material on the adhesion layer at a side far from the pattern layer; and
curing the plastic material to form the body so that the decoration film is closely attached to the body by the adhesion layer.

13. The method for manufacturing the decoration device as claimed in claim 12, wherein the plastic material is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof.

14. The method for manufacturing the decoration device as claimed in claim 11, wherein a method for attaching the body to the adhesion layer closely comprises:
disposing the decoration film on the body;
performing a heat transfer printing process to the decoration film;
disposing the decoration film and the body in a chamber; and
extracting air from the chamber, so that the decoration film is closely attached to the body by the adhesion layer.

15. The method for manufacturing the decoration device as claimed in claim 14, wherein the heat transfer printing process comprises a heating process and a pressing process.

16. The method for manufacturing the decoration device as claimed in claim 11, wherein before the pattern layer is formed, the method further comprises:
forming a durable layer on the releasing layer.

17. The method for manufacturing the decoration device as claimed in claim 16, wherein the durable layer has a thickness of at least 5 μm.

18. The method for manufacturing the decoration device as claimed in claim 11, wherein after the body is formed, the method further comprises:
removing the substrate and the releasing layer thereon from the body by applying a release force.

19. The method for manufacturing the decoration device as claimed in claim 11, wherein the adhesion layer has a thickness of at least 5 μm.

20. The method for manufacturing the decoration device as claimed in claim 11, wherein the pattern layer has a thickness of at least 1 μm.
